(19) United States
(12) Patent Application Publication
(10) Pub. No.: US 2024/0264890 A1
(43) Pub. Date: Aug. 8, 2024

(54) METHOD AND SYSTEM FOR ANALYZING CLOUD PLATFORM LOGS, DEVICE AND MEDIUM

(71) Applicant: INSPUR SUZHOU INTELLIGENT TECHNOLOGY CO., LTD, Suzhou (CN)

(72) Inventor: Yuehui Lei, Jinan (CN)

(21) Appl. No.: 18/270,431

(22) PCT Filed: Sep. 29, 2021
(86) PCT No.: PCT/CN2021/121902

§ 371 Date: Apr. 22, 2024

(30) Foreign Application Priority Data
Jul. 15, 2021 (CN) 202110801817.9

(51) Int. Cl. G06F 11/07

(52) U.S. Cl. CPC G06F 11/0769; G06F 11/0781

(57) ABSTRACT

The present application discloses a method and system for analyzing cloud platform logs, a device, and a storage medium. The method includes: preprocessing cloud platform logs, equally dividing the time for recording logs into a plurality of time periods according to a preset time length, and counting the total number of logs in each time period; selecting a time window including a plurality of consecutive time periods, classifying each time period in the time window according to a dissimilarity value so as to obtain an exception class, and according to the time corresponding to a log in the exception class, determining a time period in which a fault occurred; performing word segmentation on a log from the time period in which the fault occurred, and calculating a term frequency and an inverse document frequency of each word; and according to the product of the term frequency and the inverse document frequency, determining a reason for which the fault occurred. In the present application, the time period in which a fault occurred is determined by means of clustering, and the reason for which the fault occurred is determined according to the term frequency and the inverse document frequency, such that cloud platform logs can be analyzed quickly, and the operation and maintenance efficiency of operation and maintenance personnel is increased.

### CROSS-REFERENCE TO RELATED APPLICATION

This application claims priority to Chinese patent application No. 202110801817.9, filed with Chinese Patent Office on Jul. 15, 2021, entitled “Method and System for Analyzing Cloud Platform Logs, Device and Medium”, which is incorporated herein by reference in its entirety.

### TECHNICAL FIELD

The present application relates to the field of log analysis, and more specifically, to a method and system for analyzing cloud platform logs, a computer device and a readable medium.

### BACKGROUND

With the rapid development of cloud computing, more and more enterprises have put their company business and systems onto a cloud platform, which can quickly build a development environment and allocate computing resources according to needs of different users, and has the advantages of resilience, rapidity and on-demand. For a cloud platform, it is very important to ensure system reliability. For many enterprise-level large-scale cloud computing services, there may be thousands of nodes, and the numerous nodes are very prone to faults. Besides, due to the complexity of the cloud platform services, some problems are difficult to find and solve in a timely manner, which brings a huge workload to operation and maintenance personnel. Logs are an important record carrier of system operation status, and the operation and maintenance personnel can locate service exception by the logs to provide a basis for stable operation of the system.

System log management tools currently on the market generally collect logs in a centralized manner and index the logs so that operations and maintenance personnel implement searching, analyzing, monitoring and visualizing functions. However, these tools do not analyze the logs in depth, and it still needs to interpret and analyze the logs manually to determine whether there is exception in the system. Due to the large number of logs, manual checking is extremely time-consuming, such that system exception cannot be discovered timely and judgments cannot be made accurately.

### SUMMARY OF THE INVENTION

In view of this, an object of embodiments of the present application is proposing a method and system for analyzing cloud platform logs, a computer device and a computer readable medium. In the present application, a time period in which a fault occurred is determined by means of clustering, and a reason for which the fault occurred is determined according to a term frequency and an inverse document frequency, such that cloud platform logs can be analyzed quickly, and the operation and maintenance efficiency of operation and maintenance personnel is increased.

Based on the above object, in a first aspect of embodiments of the present application, a method for analyzing cloud platform logs is provided, which includes the following steps: preprocessing cloud platform logs, equally dividing the time for recording logs into a plurality of time periods according to a preset time length, and counting the total number of logs in each time period; selecting a time window including a plurality of consecutive time periods, classifying each time period in the time window according to a dissimilarity value so as to obtain an exception class, and according to the time corresponding to a log in the exception class, determining a time period in which a fault occurred; performing word segmentation on a log from the time period in which the fault occurred, and calculating a term frequency and an inverse document frequency of each word; and according to the product of the term frequency and the inverse document frequency, determining a reason for which the fault occurred.

In some implementations, the step of classifying each time period in the time window according to a dissimilarity value so as to obtain an exception class includes: randomly selecting, from the time window, a first number of time periods as initial center points; successively calculating dissimilarity values of each remaining time period to every one of the initial center points, and according to the dissimilarity values, assigning each remaining time period to a corresponding initial center point to form a plurality of clusters; and calculating the sum of squared errors of each cluster, determining a new center point in each cluster according to the sum of squared errors, and calculating dissimilarity values again based on a new plurality of center points and repeating the above steps until a clustering condition is met.

In some implementations, the step of, according to the dissimilarity values, assigning each remaining time period to a corresponding initial center point to form a plurality of clusters includes: determining the lowest dissimilarity value corresponding to a current time period to be assigned, and assigning the current time period to an initial center point corresponding to the lowest dissimilarity value.

In some implementations, the step of repeating the above steps until a clustering condition is met includes: judging whether there is an inflection point in the magnitude of the sum of squared errors of a cluster; and stopping repeating the above steps in response to the presence of an inflection point in the magnitude of the sum of squared errors of a cluster.

In some implementations, the step of, according to the time corresponding to a log in the exception class, determining a time period in which a fault occurred includes: acquiring a total number of logs in each class, and judging whether there is a class in which the total number of logs is less than a threshold; and in response to the absence of a class in which the total number of logs is less than the threshold, determining the time period in which the fault occurred according to a class with the smallest total number of logs.

In some implementations, the step of, according to the time corresponding to a log in the exception class, determining a time period in which a fault occurred includes: in response to the presence of a class in which the total number of logs is less than the threshold, determining the time period in which the fault occurred according to a class with the smallest total number of logs among classes in which the total number of logs is greater than or equal to the threshold and according to the class in which the total number of logs is less than the threshold.

In some implementations, the step of, according to the product of the term frequency and the inverse document frequency, determining a reason for which the fault occurred includes: calculating the product of the term frequency and the inverse document frequency of each word, and ranking corresponding words in an order from the largest product to the smallest product; and determining the reason for which the fault occurred according to a preset number of words that rank top.

In another aspect of embodiments of the present application, a system for analyzing cloud platform logs is provided, which includes: a preprocessing module configured to preprocess cloud platform logs, equally divide the time for recording logs into a plurality of time periods according to a preset time length, and count the total number of logs in each time period; a classification module configured to select a time window including a plurality of consecutive time periods, classify each time period in the time window according to a dissimilarity value so as to obtain an exception class, and according to the time corresponding to a log in the exception class, determine a time period in which a fault occurred; a calculation module configured to perform word segmentation on a log from the time period in which the fault occurred, and calculate a term frequency and an inverse document frequency of each word; and an analysis module configured to, according to the product of the term frequency and the inverse document frequency, determine a reason for which the fault occurred.

In yet another aspect of embodiments of the present application, a computer device is also provided, which includes: at least one processor; and a memory configured to store computer instructions that can be run on the processor, wherein the instructions, when executed by the processor, implement the steps of the method as described above.

In a further aspect of embodiments of the present application, a computer readable storage medium is also provided, which is configured to store a computer program, which when executed by a processor, executes the steps of the method as described above.

The present application has the following beneficial technical effects: the time period in which a fault occurred is determined by means of clustering, and the reason for which the fault occurred is determined according to the term frequency and the inverse document frequency, such that cloud platform logs can be analyzed quickly, and the operation and maintenance efficiency of operation and maintenance personnel is increased.

### BRIEF DESCRIPTION OF THE DRAWINGS

To more clearly describe technical solutions in embodiments of the present application or in the prior art, a brief introduction to the drawings for use in description of embodiments or the prior art will be given below. Obviously, the drawings described below are only some embodiments in the present application, and to those of ordinary skill in the art, other drawings may also be obtained based on these drawings without creative work.

FIG. 1 is a schematic diagram of an embodiment of a method for analyzing cloud platform logs provided in the present application;

FIG. 2 is a hardware structure diagram of an embodiment of a computer device for exception analysis of cloud platform logs provided in the present application; and

FIG. 3 is a schematic diagram of an embodiment of a computer storage medium for exception analysis of cloud platform logs provided in the present application.

### DETAILED DESCRIPTION

To make the objects, technical solutions and advantages of the present application clearer and more apparent, embodiments of the present application will be further described in detail below in conjunction with specific embodiments and with reference to the accompanying drawings.

It should be noted that all expressions with the term “first” and “second” in embodiments of the present application are used to distinguish two non-identical entities or non-identical parameter with the same name. Hence, the term “first” and “second” are only for the convenience of expression and should not be construed as limitations of embodiments of the present application, which will not be explained one by one in subsequent embodiments.

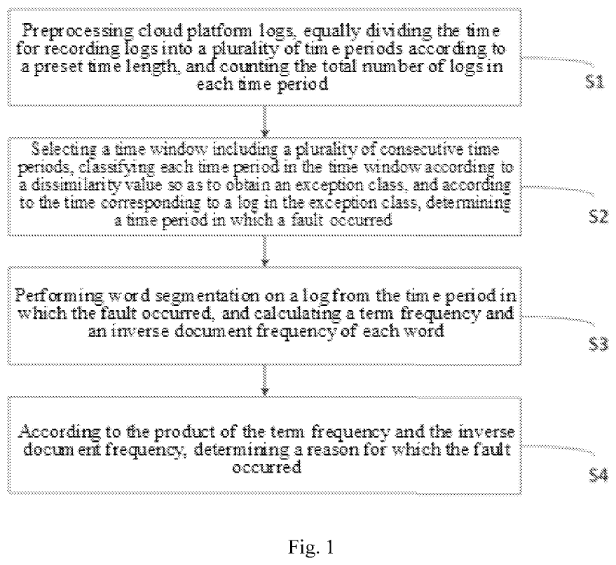

In a first aspect of embodiments of the present application, an embodiment of a method for analyzing cloud platform logs is proposed. FIG. 1 shows a schematic diagram of an embodiment of a method for analyzing cloud platform logs provided in the present application. As shown in FIG. 1, the embodiment of the present application includes the following steps:
S1, preprocessing cloud platform logs, equally dividing the time for recording logs into a plurality of time periods according to a preset time length, and counting the total number of logs in each time period;
S2, selecting a time window including a plurality of consecutive time periods, classifying each time period in the time window according to a dissimilarity value so as to obtain an exception class, and according to the time corresponding to a log in the exception class, determining a time period in which a fault occurred;
S3, performing word segmentation on a log from the time period in which the fault occurred, and calculating a term frequency and an inverse document frequency of each word: and
S4, according to the product of the term frequency and the inverse document frequency, determining a reason for which the fault occurred.

Logs generated by a cloud platform include a large number of duplicate logs, and these logs will interfere with detection results if they appear in large numbers. Furthermore, a log format generated by the cloud platform is semi-structured, so the logs need to be preprocessed to obtain a normalized log format. Processed logs are not stored by using primitive virtual machine objects. Instead, data are stored in a table structure, and an in-memory column is used for efficient storage. Then, a K-means clustering algorithm is used to obtain an approximate fault time period, and finally a TF-IDF algorithm is used to output a reason for which a fault occurred.

The K-means clustering algorithm is an iterative solution-based cluster analysis algorithm, and is the most commonly used Euclidean distance-based clustering algorithm, according to which, the closer the distance between two targets, the greater the similarity therebetween. TF-IDF (term frequency-inverse document frequency) is a common weighting technique for information retrieval and data mining. TF represents term frequency, which is the frequency a term occurs. The number of times a term occurs is counted, and divided by the sum of the numbers of all terms to obtain a result as statistical information. IDF represents inverse document frequency, which reflects the frequency a term occurs across all documents in a corpus. If a term occurs in many documents, the inverse document frequency value of the term should be low, indicating that the term is less significant in judging text content.

Cloud platform logs are preprocessed, the time for recording logs is equally divided into a plurality of time periods according to a preset time length, and the total number of logs in each time period is counted.

In some implementations, the step of preprocessing cloud platform logs includes: filtering duplicate logs, and converting the logs after filtering to a standard format. Cloud platform log preprocessing includes two steps. A first step is filtering duplicate logs, and a second step is formatting logs. Each log can be divided into five parts: timestamp, log address, code module, log level and specific log content.

In some implementations, the analyzing method further includes: storing the logs in the standard format in a table structure, and storing the table structure in an in-memory column. In order to improve log reading efficiency, instead of storing cloud platform logs by using primitive virtual machine objects, data are stored in a table structure, and an in-memory column is used for efficient storage. The in-memory column storage can greatly reduce space occupation, and also improve the throughput of reading data, and is suitable for processing a large number of logs.

A time window including a plurality of consecutive time periods is selected, each time period in the time window is classified according to a dissimilarity value so as to obtain an exception class, and a time period in which a fault occurred is determined according to the time corresponding to a log in the exception class.

The number of logs of a stably running cloud platform system is distributed relatively uniformly. Based on this idea, the number of logs can be used as a basis to extract features of the logs. Using time as a primary key, the number of entries of logs for a current time period is counted. For example, if a time interval is set to a minute, then each minute is used as an identifier for each row of data. A time point is selected as the center of the time window, and the number of logs in a time period to which the time point belongs is calculated as a feature. Using the time point as the center, N time periods before and N time periods after the time of the center point are selected to form a time window of 2N+1 time periods, and the number of logs in each time period is used as a feature, so there are a total of 2N+1 features. The time periods here can be fixed, or not fixed. For example, the length of time can be fixed to one minute, and 2 minutes before and 2 minutes after the center point are taken to form a time window of 5 time periods. In addition, it is also possible to take 1 minute, 2 minutes, and 3 minutes before it and 1 minute, 2 minutes, and 3 minutes after it to form a time window of 7 time periods.

In some implementations, the step of classifying each time period in the time window according to a dissimilarity value so as to obtain an exception class includes: randomly selecting, from the time window, a first number of time periods as initial center points; successively calculating dissimilarity values of each remaining time period to every one of the initial center points, and according to the dissimilarity values, assigning each remaining time period to a corresponding initial center point to form a plurality of clusters; and calculating the sum of squared errors of each cluster, determining a new center point in each cluster according to the sum of squared errors, and calculating dissimilarity values again based on a new plurality of center points and repeating the above steps until a clustering condition is met.

In some implementations, the step of, according to the dissimilarity values, assigning each remaining time period to a corresponding initial center point to form a plurality of clusters includes: determining the lowest dissimilarity value corresponding to a current time period to be assigned, and assigning the current time period to an initial center point corresponding to the lowest dissimilarity value. For example, there are a total of 100 time periods in a time window, and 4 time periods are randomly selected from the time window as initial center points. For example, they may be A, B, C and D. Then, dissimilarity values of the remaining 96 time periods to every one of the initial center points are calculated. For example, a1 is one of the remaining 96 time periods. A dissimilarity value A1 of a1 to A, a dissimilarity value B1 of a1 to B, a dissimilarity value C1 of a1 to C, and a dissimilarity value D1 of a1 to D are calculated. The magnitudes of A1, B1, C1 and D1 are compared. Assuming that C1 is the smallest, a1 is assigned to a cluster corresponding to C. After the remaining 96 time periods are all assigned, the sum of squared errors of each cluster is calculated, respectively. The formula for calculating the sum of squared errors can be as follows:

$$S S E = {\sum }_{i = 1}^{k} {\sum }_{p ∈ {C}_{i}} {\vert p - {m}_{i} \vert}^{2}$$

where Cᵢ represents an ith cluster, p represents samples in Cᵢ, and mᵢ represents the mean of all the samples in Cᵢ. SSE represents a clustering error of all sample points, and can indicate whether a clustering effect is good or not.

Then, a new center point is determined in each cluster according to the sum of squared errors. Specifically, a time period with the smallest sum of squared errors in the cluster can be selected as the new center point. After the new center point of each cluster is determined, dissimilarity values of the remaining time periods to every one of the center points are calculated again. For example, the new center points are a2, B, a3, and a10, respectively, and dissimilarity values of the remaining 96 time periods other than the above-mentioned new center points to every one of the center points can be calculated. For example, a dissimilarity value A2 of A to a2, a dissimilarity value B2 of A to B, a dissimilarity value C2 of A to a3, and a dissimilarity value D2 of A to a10 can be calculated. Assuming that B2 is the smallest, A is assigned to a cluster corresponding to B. After all the remaining 96 time periods are assigned, the sum of squared errors of each cluster is calculated, respectively, and new center points are selected again until a clustering condition is met.

In some implementations, the step of repeating the above steps until a clustering condition is met includes: judging whether there is an inflection point in the magnitude of the sum of squared errors of a cluster; and stopping repeating the above steps in response to the presence of an inflection point in the magnitude of the sum of squared errors of a cluster. For example, if the values of the sum of squared error are 10, 8, 7, 5, and 6, respectively, showing that it had been in a decreasing trend previously, but suddenly increased last time, indicating an inflection point, then the above steps can be stopped.

In some implementations, the above steps can be continued for clusters where no inflection point has appeared in the sum of squared errors until inflection points have appeared in all the clusters.

Finally, four types of results can be obtained, and can be classified into an exception class and a normal class according to the number of logs in each class, and based on the time in the exception class, a suspicious time interval in which a fault occurred can be found according to a raw log. In general, a class with the largest number of logs is in a normal class, a class with a relatively large number of logs is in a class on the edge of a fault, a class with a relatively small number of logs is an exception class that is completely in a fault, and a class with the smallest number of logs is in a class with very few logs due to initial system startup or log missing.

In some implementations, the step of, according to the time corresponding to a log in the exception class, determining a time period in which a fault occurred includes: acquiring a total number of logs in each class, and judging whether there is a class in which the total number of logs is less than a threshold; and in response to the absence of a class in which the total number of logs is less than the threshold, determining the time period in which the fault occurred according to a class with the smallest total number of logs. The threshold can be used to judge whether there is a class of initial system startup or log missing. If the total number of logs in each class is greater than or equal to the threshold, it indicates there is no class of initial system startup or log missing, and in this case, the time period in which the fault occurred can be determined according to a class with the smallest total number of logs.

In some implementations, the step of, according to the time corresponding to a log in the exception class, determining a time period in which a fault occurred includes: in response to the presence of a class in which the total number of logs is less than the threshold, determining the time period in which the fault occurred according to a class with the smallest total number of logs among classes in which the total number of logs is greater than or equal to the threshold and according to the class in which the total number of logs is less than the threshold. If there is a class in which the total number of logs is less than the threshold, it indicates that there is a class of initial system startup or log missing. Such classes can be classified as exception classes. In addition, among classes in which the total number of logs is greater than or equal to the threshold, a class with the smallest total number of logs can also be classified as an exception class. Thus, the time period in which the fault occurred can be determined according to the exception classes.

Word segmentation is performed on a log from the time period in which the fault occurred, and a term frequency and an inverse document frequency of each word are calculated. A reason for which the fault occurred is determined according to the product of the term frequency and the inverse document frequency. After a log in an exception class is extracted, word segmentation is performed on the log, and a stop word list is created. Words are indexed, which will increase the speed during subsequent queries. The words are transformed into word vectors, and using a TF-IDF algorithm, numerical values of the words are calculated and ranked from highest to lowest, and output based on a certain number. In processing a log, word segmentation is performed on the log first, and after that, a document originally composed of sentences become numerous words, some of which are very common, such as “it”, “of”, “I” and so on. These words have little significance for the analysis of the document, and in many cases can affect an analysis result and have a negative effect on the analysis. Moreover, too many such words can also increase the computational complexity of the algorithm, so the words are called stop words.

In some implementations, the step of, according to the product of the term frequency and the inverse document frequency, determining a reason for which the fault occurred includes: calculating the product of the term frequency and the inverse document frequency of each word, and ranking corresponding words in an order from the largest product to the smallest product; and determining the reason for which the fault occurred according to a preset number of words that rank top.

The formulas for calculating the term frequency and the inverse document frequency are as follows:

$$T F = \frac{count ( w )}{\vert D \vert}$$

$$IDF = log ( \frac{N}{1 + {Σ}_{i = 1}^{N} I ( w , {D}_{i} )} )$$

where TF represents the term frequency, count(w) represents the number of words, |D| represents the number of documents, IDF represents the inverse document frequency, N represents the total number of all documents in a corpus; I(w, Dᵢ) represents whether a word w has appeared in a document Di, and is 1 if it has appeared and is 0 if it has not.

After the term frequency and the inverse document frequency are calculated, the two values are multiplied to get a result which is the final TF-IDF value obtained: TF-IDF=TF×IDF. TF-IDF is able to extract a topic of the log and find from the log the most critical information in the log for this period of time to make a judgment on the fault. A larger calculated value of TF-IDF indicates that the word is more representative of the main content of the document. Thus, the words are ranked from the largest value to the smallest value. The reason for the fault can be found from the top 20 words.

In the present application, the time period in which a fault occurred is determined by means of clustering, and the reason for which the fault occurred is determined according to the term frequency and the inverse document frequency, such that cloud platform logs can be analyzed quickly, and the operation and maintenance efficiency of operation and maintenance personnel is increased.

It should be noted particularly that the steps in the above embodiments of the method for analyzing cloud platform logs can be crossed with, substituted for, or added to each other, or deleted, so these reasonable arrangements, combinations and transformations for the method for analyzing cloud platform logs should also fall within the scope of protection of the present application, and the scope of protection of the present application should not be limited to the embodiments.

Based on the above object, in a second aspect of embodiments of the present application, a system for analyzing cloud platform logs is proposed, which includes: a preprocessing module configured to preprocess cloud platform logs, equally divide the time for recording logs into a plurality of time periods according to a preset time length, and count the total number of logs in each time period; a classification module configured to select a time window including a plurality of consecutive time periods, classify each time period in the time window according to a dissimilarity value so as to obtain an exception class, and according to the time corresponding to a log in the exception class, determine a time period in which a fault occurred; a calculation module configured to perform word segmentation on a log from the time period in which the fault occurred, and calculate a term frequency and an inverse document frequency of each word; and an analysis module configured to, according to the product of the term frequency and the inverse document frequency, determine a reason for which the fault occurred.

In some implementations, the classification module is configured to: randomly select, from the time window, a first number of time periods as initial center points; successively calculate dissimilarity values of each remaining time period to every one of the initial center points, and according to the dissimilarity values, assign each remaining time period to a corresponding initial center point to form a plurality of clusters; and calculate the sum of squared errors of each cluster, determine a new center point in each cluster according to the sum of squared errors, and calculate dissimilarity values again based on a new plurality of center points and repeat the above steps until a clustering condition is met.

In some implementations, the classification module is configured to: determine the lowest dissimilarity value corresponding to a current time period to be assigned, and assign the current time period to an initial center point corresponding to the lowest dissimilarity value.

In some implementations, the classification module is configured to: judge whether there is an inflection point in the magnitude of the sum of squared errors of a cluster; and stop repeating the above steps in response to the presence of an inflection point in the magnitude of the sum of squared errors of a cluster.

In some implementations, the classification module is configured to: acquire a total number of logs in each class, and judge whether there is a class in which the total number of logs is less than a threshold; and in response to the absence of a class in which the total number of logs is less than the threshold, determine the time period in which the fault occurred according to a class with the smallest total number of logs.

In some implementations, the classification module is configured to: in response to the presence of a class in which the total number of logs is less than the threshold, determine the time period in which the fault occurred according to a class with the smallest total number of logs among classes in which the total number of logs is greater than or equal to the threshold and according to the class in which the total number of logs is less than the threshold.

In some implementations, the analysis module is configured to: calculate the product of the term frequency and the inverse document frequency of each word, and rank corresponding words in an order from the largest product to the smallest product; and determine the reason for which the fault occurred according to a preset number of words that rank top.

Based on the above object, in a third aspect of embodiments of the present application, a computer device is proposed, which includes: at least one processor; and a memory configured to store computer instructions that can be run on the processor, wherein the instructions, when executed by the processor, implement the following steps: S1, preprocessing cloud platform logs, equally dividing the time for recording logs into a plurality of time periods according to a preset time length, and counting the total number of logs in each time period; S2, selecting a time window including a plurality of consecutive time periods, classifying each time period in the time window according to a dissimilarity value so as to obtain an exception class, and according to the time corresponding to a log in the exception class, determining a time period in which a fault occurred; S3, performing word segmentation on a log from the time period in which the fault occurred, and calculating a term frequency and an inverse document frequency of each word; and S4, according to the product of the term frequency and the inverse document frequency, determining a reason for which the fault occurred.

In some implementations, the step of classifying each time period in the time window according to a dissimilarity value so as to obtain an exception class includes: randomly selecting, from the time window, a first number of time periods as initial center points; successively calculating dissimilarity values of each remaining time period to every one of the initial center points, and according to the dissimilarity values, assigning each remaining time period to a corresponding initial center point to form a plurality of clusters; and calculating the sum of squared errors of each cluster, determining a new center point in each cluster according to the sum of squared errors, and calculating dissimilarity values again based on a new plurality of center points and repeating the above steps until a clustering condition is met.

In some implementations, the step of, according to the dissimilarity values, assigning each remaining time period to a corresponding initial center point to form a plurality of clusters includes: determining the lowest dissimilarity value corresponding to a current time period to be assigned, and assigning the current time period to an initial center point corresponding to the lowest dissimilarity value.

In some implementations, the step of repeating the above steps until a clustering condition is met includes: judging whether there is an inflection point in the magnitude of the sum of squared errors of a cluster; and stopping repeating the above steps in response to the presence of an inflection point in the magnitude of the sum of squared errors of a cluster.

In some implementations, the step of, according to the time corresponding to a log in the exception class, determining a time period in which a fault occurred includes: acquiring a total number of logs in each class, and judging whether there is a class in which the total number of logs is less than a threshold; and in response to the absence of a class in which the total number of logs is less than the threshold, determining the time period in which the fault occurred according to a class with the smallest total number of logs.

In some implementations, the step of, according to the time corresponding to a log in the exception class, determining a time period in which a fault occurred includes: in response to the presence of a class in which the total number of logs is less than the threshold, determining the time period in which the fault occurred according to a class with the smallest total number of logs among classes in which the total number of logs is greater than or equal to the threshold and according to the class in which the total number of logs is less than the threshold.

In some implementations, the step of, according to the product of the term frequency and the inverse document frequency, determining a reason for which the fault occurred includes: calculating the product of the term frequency and the inverse document frequency of each word, and ranking corresponding words in an order from the largest product to the smallest product; and determining the reason for which the fault occurred according to a preset number of words that rank top.

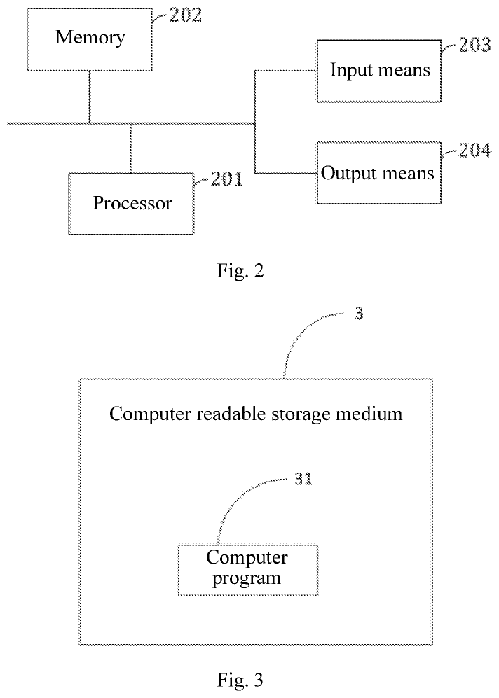

FIG. 2 shows a hardware structure diagram of an embodiment of the above-mentioned computer device for exception analysis of cloud platform logs provided in the present application.

Using the device shown in FIG. 2 as an example, the device includes a processor 201 and a memory 202, and may also include an input means 203 and an output means 204.

The processor 201, the memory 202, the input means 203 and the output means 204 may be connected via a bus or by other means. Connection via a bus is used in FIG. 2 as an example.

The memory 202, as a non-volatile computer readable storage medium, may be configured to store non-volatile software programs, non-volatile computer executable programs and modules, such as program instructions/modules corresponding to the method for analyzing cloud platform logs in embodiments of the present application. The processor 201 runs the non-volatile software programs, instructions and modules stored in the memory 202 to execute various function applications of a server and data processing, i.e., implementing the method for analyzing cloud platform logs in the above method embodiment.

The memory 202 may include a program storing area and a data storing area, wherein the program storing area may store an operating system, and an application program required for at least one function; and the data storing area may store data created according to the use of the method for analyzing cloud platform logs, and the like. In addition, the memory 202 may include a high-speed random access memory, and may also include a non-volatile memory, such as at least one disk storage device, flash memory device or other non-volatile solid-state memory device. In some embodiment, the memory 202 includes memories arranged remotely relative to the processor 201, and these remote memories may be connected to a local module via a network connection. Examples of the network described above include, but are not limited to, the Internet, an intranet, a local area network, a mobile communication network and combinations thereof.

The input means 203 may receive the input information such as user name and password. The output means 204 may include a display device such as a display screen.

Program instructions/modules corresponding to one or more methods for analyzing cloud platform logs are stored in the memory 202, and when executed by the processor 201, execute the method for analyzing cloud platform logs in any method embodiment described above.

Any embodiment of the computer device that executes the method for analyzing cloud platform logs described above can achieve the same or similar effect as any previous method embodiment corresponding thereto.

The present application also provides a computer readable storage medium configured to store a computer program, which when executed by a processor, executes the method as described above.

FIG. 3 shows a schematic diagram of an embodiment of the above-mentioned computer storage medium for exception analysis of cloud platform logs provided in the present application. Using the computer storage medium shown in FIG. 3 as an example, the computer readable storage medium 3 stores a computer program 31, which when executed by a processor, executes the method as described above.

Finally, it should be noted that those of ordinary skill in the art can understand that all or part of the processes in the methods in the above embodiments may be implemented by relevant hardware instructed by a computer program, and the program of the method for analyzing cloud platform logs may be stored in a computer readable storage medium. The program, when executed, may include the processes of the above method embodiments. The storage medium of the program may be a magnetic disk, an optical disk, a read-only memory (ROM), a random access memory (RAM), or the like. The above computer program embodiment can achieve the same or similar effect as any previous method embodiment corresponding thereto.

Described above are exemplary embodiments disclosed in the present application, but it should be noted that various changes and modifications can be made without departing from the scope of disclosure of embodiments of the present application defined by the claims. Functions, steps, and/or operations of method claims according to the disclosed embodiments described herein need not be performed in any particular order. In addition, although elements disclosed in embodiments of the present application may be described or claimed in individual form, they may also be understood to be plural unless expressly limited to a singular number.

It should be understood that, as used herein, the singular form “a/an” is intended to include a plural form as well, unless the context clearly supports an exception. It is also to be understood that “and/or” as used herein refers to any and all possible combinations including one or more items listed in connection therewith.

The sequence numbers of the above embodiments disclosed in embodiments of the present application are only for description, and do not represent the degree of superiority of the embodiments.

Those of ordinary skill in the art can understand that all or part of the steps in the above embodiments may be implemented by hardware, or by hardware instructed by a program. The program may be stored in a computer readable storage medium. The above-mentioned storage medium may be a read only memory, a magnetic disk, an optical disk, or the like.

Those of ordinary skill in the art should understand that the discussion of any of the above embodiments is exemplary only and is not intended to imply that the scope of disclosure of embodiments of the present application (including the claims) is limited to these examples; in the idea of embodiments of the present applications, the technical features of the above embodiments or different embodiments may also be combined, and there are many other variations of different aspects of embodiments of the present applications as described above, which are not provided in details for the sake of brevity. Therefore, all omissions, modifications, equivalent substitutions, improvements and the like made within the spirit and principle of embodiments of the present application should be encompassed within the protection scope of embodiments of the present application.

1. A method for analyzing cloud platform logs, comprising the following steps:
preprocessing cloud platform logs, equally dividing the time for recording logs into a plurality of time periods according to a preset time length, and counting the total number of logs in each time period;
selecting a time window comprising a plurality of consecutive time periods, classifying each time period in the time window according to a dissimilarity value so as to obtain an exception class, and according to the time corresponding to a log in the exception class, determining a time period in which a fault occurred;
performing word segmentation on a log from the time period in which the fault occurred, and calculating a term frequency and an inverse document frequency of each word; and
according to the product of the term frequency and the inverse document frequency, determining a reason for which the fault occurred.

2. The analyzing method according to claim 1, wherein the step of classifying each time period in the time window according to a dissimilarity value so as to obtain an exception class comprises:
randomly selecting, from the time window, a first number of time periods as initial center points;
successively calculating dissimilarity values of each remaining time period to every one of the initial center points, and according to the dissimilarity values, assigning each remaining time period to a corresponding initial center point to form a plurality of clusters; and
calculating the sum of squared errors of each cluster, determining a new center point in each cluster according to the sum of squared errors, and calculating dissimilarity values again based on a new plurality of center points and repeating the above steps until a clustering condition is met.

3. The analyzing method according to claim 2, wherein the step of, according to the dissimilarity values, assigning each remaining time period to a corresponding initial center point to form a plurality of clusters comprises:
determining the lowest dissimilarity value corresponding to a current time period to be assigned, and assigning the current time period to an initial center point corresponding to the lowest dissimilarity value.

4. The analyzing method according to claim 2, wherein the step of repeating the above steps until a clustering condition is met comprises:
judging whether there is an inflection point in the magnitude of the sum of squared errors of a cluster; and
stopping repeating the above steps in response to the presence of an inflection point in the magnitude of the sum of squared errors of a cluster.

5. The method according to claim 1, wherein the step of, according to the time corresponding to a log in the exception class, determining a time period in which a fault occurred comprises:
acquiring a total number of logs in each class, and judging whether there is a class in which the total number of logs is less than a threshold; and
in response to the absence of a class in which the total number of logs is less than the threshold, determining the time period in which the fault occurred according to a class with the smallest total number of logs.

6. The method according to claim 5, wherein the step of, according to the time corresponding to a log in the exception class, determining a time period in which a fault occurred comprises:
in response to the presence of a class in which the total number of logs is less than the threshold, determining the time period in which the fault occurred according to a class with the smallest total number of logs among classes in which the total number of logs is greater than or equal to the threshold and according to the class in which the total number of logs is less than the threshold.

7. The analyzing method according to claim 1, wherein the step of, according to the product of the term frequency and the inverse document frequency, determining a reason for which the fault occurred comprises:
calculating the product of the term frequency and the inverse document frequency of each word, and ranking corresponding words in an order from the largest product to the smallest product; and
determining the reason for which the fault occurred according to a preset number of words that rank top.

8. A system for analyzing cloud platform logs, comprising:
a preprocessing module configured to preprocess cloud platform logs, equally divide the time for recording logs into a plurality of time periods according to a preset time length, and count the total number of logs in each time period;
a classification module configured to select a time window comprising a plurality of consecutive time periods, classify each time period in the time window according to a dissimilarity value so as to obtain an exception class, and according to the time corresponding to a log in the exception class, determine a time period in which a fault occurred;
a calculation module configured to perform word segmentation on a log from the time period in which the fault occurred, and calculate a term frequency and an inverse document frequency of each word; and
an analysis module configured to, according to the product of the term frequency and the inverse document frequency, determine a reason for which the fault occurred.

9. A computer device, comprising:
at least one processor; and
a memory configured to store computer instructions that can be run on the processor, wherein the instructions, when executed by the processor, implement the steps of the method of any one of claims 1 to 7.

10. A computer readable storage medium configured to store a computer program, wherein the computer program, when executed by a processor, implements the steps of the method of any one of claims 1 to 7.
